(19) United States
(12) Patent Application Publication
(10) Pub. No.: US 2025/0019877 A1
(43) Pub. Date: Jan. 16, 2025

(54) CARBON MONOLITHS AND METHODS OF MANUFACTURING CARBON MONOLITHS

(71) Applicant: CARBON HOLDINGS INTELLECTUAL PROPERTIES, LLC, Ranchester, WY (US)

(72) Inventors: Charles Agee Atkins, Sheridan, WY (US); Charles S. Hill, Sheridan, WY (US)

(21) Appl. No.: 18/764,885

(22) Filed: Jul. 5, 2024

Related U.S. Application Data
(60) Provisional application No. 63/512,885, filed on Jul. 10, 2023.

(51) Int. Cl. D04H 1/4242; B01D 53/26; B01D 53/28; B01J 20/20; B01J 20/28; B01J 20/30; C02F 1/20; C02F 1/28; D01F 9/15; D04H 1/56; D04H 1/724; D04H 3/16

(52) U.S. Cl. CPC D04H 1/4242; B01D 53/261; B01D 53/28; B01J 20/20; B01J 20/28038; B01J 20/28042; B01J 20/3007; B01J 20/3035; C02F 1/20; C02F 1/283; D01F 9/15; D04H 1/56; D04H 1/724; D04H 3/16; B01D 2253/102; B01D 2253/342; B01D 2257/708; B01D 2257/80; B01D 2258/06; D10B 2505/04

(57) ABSTRACT

A method of manufacturing a carbon monolith the includes obtaining coal based pitch, melt blowing the coal based pitch into a plurality of carbon fibers forming a nonwoven fiber mat, and fusing the plurality of carbon fibers at contact points between the carbon fibers. The carbon monolith does not use a binder to bind the carbon fibers together.

### CROSS-REFERENCE TO RELATED APPLICATIONS

This application claims priority to U.S. Provisional Patent Application No. 63/512,885 filed 10 Jul. 2023, entitled CARBON MONOLITHS AND METHODS OF MANUFACTURING CARBON MONOLITHS, the disclosure of which is hereby incorporated by reference in its entirety.

### FIELD

The described embodiments relate to carbon monoliths for use in a variety of different applications, such as filtration, sorbents, apparels, and drug delivery systems. Filtering application may use an activated carbon monolith and such applications may include at least, dehumidifying and purifying air; capturing, concentrating, and sequestering aqueous greenhouse gases; and capturing, concentrating, and separating volatile organic compounds. More particularly, the present embodiments relate to carbon monoliths and methods of manufacturing carbon monoliths.

### BACKGROUND

Carbon monoliths are a unitary structure formed from carbon or have a surface including carbon. Such monoliths may have an activated carbon surface and may be a solid structure or have one or more internal channels with high surface area. Activated carbon monoliths have a wide variety of uses in a gas and liquid phase adsorption, as well as catalyst applications and as electrode materials.

Activated carbon monoliths have traditionally been manufactured by assembling chopped carbon fibers with a phenolic or polyvinylidene chloride (PVDC) binder. The chopped carbon fibers and the binder undergo various degrees of compression and heat to produce activated carbon monoliths of various densities, structural features, and pore volume properties.

### SUMMARY

In at least one example, a method of manufacturing a carbon monolith includes obtaining coal based pitch, melt blowing the coal based pitch into a plurality of carbon fibers forming a nonwoven fiber mat, and fusing the plurality of carbon fibers at contact points between the carbon fibers.

In one example, the method further includes melt blowing the coal based pitch into a plurality of nonwoven fibers mats, each nonwoven fiber mat includes a plurality of carbon fibers. In one example, the method further includes stacking the plurality of nonwoven fiber mats. In one example, the method further includes compressing the stacked plurality of nonwoven fiber mats to produce the carbon monolith with a predetermined density, shape, and pore structure. In one example, the plurality of carbon fibers of each nonwoven fiber mat are randomly oriented. In one example, the coal based pitch is isotropic. In one example, the coal based pitch is anisotropic. In one example, the coal based pitch is mesophase pitch. In one example, the fusing the plurality of carbon fibers occurs during an oxygen stabilization process. In one example, the method of manufacturing a carbon monolith does not use a binder to bind the plurality of carbon fibers. In one example, the shape of the fiber mat can be designed to serve a specific function or purpose. For example, the shape of the fiber mat can correspond to a filter housing, an appliance fitting, or a system component to allow the resultant fiber mat to be enclosed and used for filtering in a known system.

In at least one example, a carbon monolith includes a plurality of nonwoven fiber mats compressed together to form the carbon monolith. Each nonwoven fiber mat of the plurality of nonwoven fiber mats includes a plurality of melt blown carbon fibers. The plurality of melt blown carbon fibers are fused together at contact points between adjacent melt blown carbon fibers.

In one example, the carbon monolith does not have a binder to bind the melt blown carbon fibers. In one example, the carbon monolith is configured to adsorb volatile organic compounds. In one example, the carbon monolith is configured to adsorb aqueous greenhouse gases from wastewater. In one example, the carbon monolith is configured to dehumidify air. In one example, the carbon monolith is configured to adsorb air contaminants. In one example, the plurality of melt blown carbon fibers of each nonwoven fiber mat are randomly oriented.

In at least one example, a carbon monolith includes a plurality of nonwoven fiber mats compressed together to form the carbon monolith. Each nonwoven fiber mat of the plurality of nonwoven fiber mats consists of a plurality of melt blown carbon fiber. The plurality of melt blown carbon fibers are fused together at contact points between adjacent melt blown carbon fibers. In one example, the plurality of melt blown carbon fibers of each nonwoven fiber mat are randomly oriented. In one example, the carbon monolith is configured to adsorb a specific compound.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 illustrates a flow chart of a method of manufacturing a carbon monolith according to one embodiment of the present disclosure.

FIG. 2 illustrates a scanning electron microscope (SEM) image of melt blown carbon fibers from coal based pitch after oxidation at 144 times magnification according to one embodiment of the present disclosure.

FIG. 3 illustrates a SEM image of melt blown carbon fibers from coal based pitch after oxidation at 595 times magnification according to one embodiment of the present disclosure.

FIG. 4 illustrates a SEM image of melt blown carbon fibers from coal based pitch after oxidation at 907 times magnification according to one embodiment of the present disclosure.

FIG. 5 illustrates a SEM image of melt blown carbon fibers from coal based pitch after oxidation at 2,280 times magnification according to one embodiment of the present disclosure.

FIG. 6 is a graphical representation of the quantity of carbon dioxide adsorbed per gram of carbon monolith and the relative pressure increase.

### DETAILED DESCRIPTION

The present description provides examples, and is not limiting of the scope, applicability, or configuration set forth in the claims. Thus, it will be understood that changes can be made in the function and arrangement of elements discussed without departing from the spirit and scope of the disclosure, and various embodiments can omit, substitute, or add other procedures or components, as appropriate. For instance, methods described can be performed in an order different from that described, and various steps can be added, omitted, or combined. Also, features described with respect to some embodiments can be combined in other embodiments.

Carbon monoliths are a unitary structure formed from carbon or have a surface including carbon. Such monoliths may have an activated carbon surface and may be a solid structure or have one or more internal channels with high surface area. Activated carbon monoliths have a wide variety of uses in a gas and liquid phase adsorption, as well as catalyst applications and as electrode materials. In gas phase adsorption applications, activated carbon monoliths may be used in electrical swing adsorption (ESA) process, where the monolith can be quickly regenerated by application of electric current. For liquid phase applications, activated carbon monoliths may offer high efficiency adsorption in a flow through configuration.

Activated carbon monoliths have been manufactured by assembling chopped carbon fibers with a phenolic or polyvinylidene chloride (PVDC) binder. The chopped carbon fibers and the binder undergo various degrees of compression and heat to produce activated carbon monoliths of various densities, structural features, and pore volume properties.

One known method of preparing carbon monoliths includes a two-step procedure. See ChemElectroChem 10.10.1002/celc.201600848, pp. 18-21, incorporated herein by reference for all that it teaches. In a first step, powered anthracite is activated in the presence of potassium hydroxide (“KOH”) as an activating agent. Anthracite and solid KOH are ground and mixed using KOH/anthracite weight ratios. The mixtures are heated under a nitrogen flow at a heating rate of 5° C. minute from room temperature to 700° C. for an hour. The product is washed with a hydrochloric acid solution and distilled water and then dried.

The prior art teaches that carbon monoliths cannot be obtained by compaction or compression of powdered activated carbons without the addition of another component, specifically a binder. See ChemElectroChem 10.10.1002/celc.201600848, pp. 6 and 18. The binder is a material or substance that holds or draws the anthracite together to form a cohesive whole. In other words, the binder traditionally held the carbon together to form the carbon monolith. The amount of binder use needs to be sufficient for the cohesion of the carbon monolith and the amount of binder can change the porosity of the carbon monoliths.

The second step of preparing the carbon monoliths includes mixing the activated anthracite previously produced with a 55 wt. % aqueous dispersion of polyvinylidene chloride (“PVDC”). The PVDC acts as a binder to hold the activated anthracite together. The mixtures are dried, ground, and compacted in a mold with a pressure of 260 MPa. Subsequently, the mold with the compacted mixture is heated up to 140° C. The conformed carbon monoliths are then carbonized in a furnace under a nitrogen flow up to 750° C.

The present disclosure is directed to methods of manufacturing carbon monoliths using coal based pitch. The disclosed method of manufacturing carbon monoliths eliminates process steps from the above-noted prior art manufacturing process. Specifically the binder, e.g., PVDC, is removed from the manufacturing process as are the two heating steps from the second step of adding the binder to the activated anthracite to form the carbon monolith. Typically binders have to be carbonized before activation, and since there is no binder, there is no need to carbonize the binder thus eliminated a step. The removal of the binder and the removal of process step saves overall costs in the manufacturing process of the carbon monolith.

The carbon monoliths of the present disclosure are made of coal-based activated carbon fibers. The carbon monolith and the activated carbon fibers of the carbon monolith may be optimized for the adsorption of specific compounds, as discussed in more detail below. The carbon fibers may be manufactured from coal feedstock, which allows them to be 50% to 75% more economical than existing carbon fibers on the market produced from polyacrylonitrile (PAN), rayon, and petroleum pitch precursors.

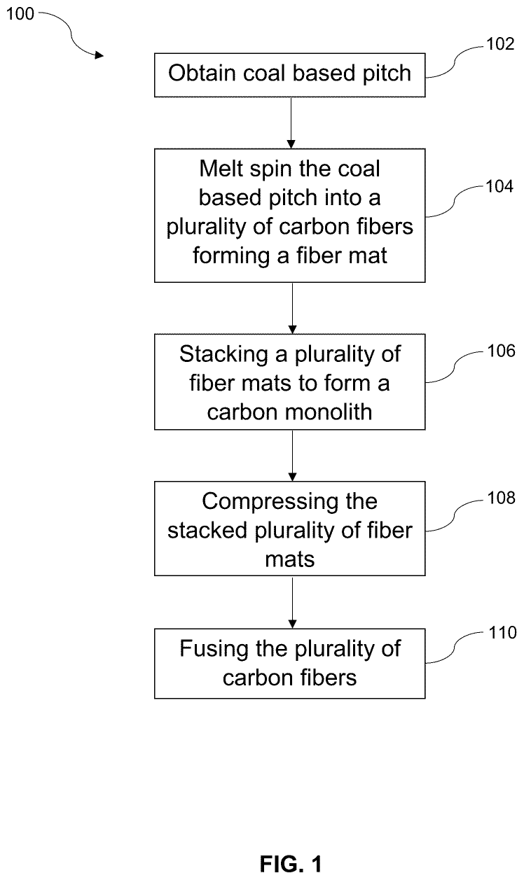

FIG. 1 illustrates a flow chart of a method 100 of manufacturing a carbon monolith according to one embodiment of the present disclosure. Step 102 is directed to obtaining coal based pitch for producing carbon fibers. Pitch is a viscoelastic material that is composed of aromatic hydrocarbons. Pitch is produced via the distillation of carbon-based materials, such as plants, crude oil, and coal. Pitch is isotropic, but can be made anisotropic through the use of heat treatments. In some embodiments, the pitch may be mesophase.

Mesophase pitch form a thermotropic crystal, which allows the pitch to become organized and form linear chains without the use of tension. Mesophase pitch is made by polymerizing isotropic pitch to a higher molecular weight. The melting point for the mesophase pitch is roughly 300° C. An advantage in the production of pitch carbon fibers over PAN carbon fibers is that pitch carbon fibers do not require constant tension on the fibers at all processing stages. Pitch based carbon fibers have been found to be more sheet-like in their crystal structure, as opposed to PAN based carbon fibers, which are more granular.

Step 104 is directed to melt blowing the coal based pitch into carbon fibers. Melt blowing is a process of fabricating micro- and nanofibers. The coal based pitch is extruded through small nozzles surrounded by high speed blowing gas which forms coal based carbon fibers. The carbon fibers may be deposited to form a nonwoven fiber mat of randomly oriented carbon fibers. Accordingly, each nonwoven fiber mat has melt blown carbon fibers. The nonwoven fiber mat may include a number of different properties, such as porosity, average pore diameter, average fiber diameter, Brunauer-Emmett-Teller (BET) surface area, thermal conductivity, and electrical resistance. These properties may be adjusted or customized during melt blowing process or during the method 100 of manufacturing the carbon monolith to achieve a predetermined result for the properties carbon fibers themselves as well as the properties of the nonwoven fiber mat. The nonwoven fiber mat may be applicable for a number of different applications. For example, filtration, sorbents, apparels, and drug delivery systems. As discussed in more detail below, the properties of the carbon fibers may be tailored so that selective adsorption of specific predetermined of compounds is achieved in filtration.

Step 106 is directed to stacking a plurality of nonwoven fiber mats. The stacked plurality of nonwoven fiber mats may be arranged in predetermined configuration or shape, such as cylinders, cuboids, and the like. The stacked plurality of nonwoven fibers mats may include properties that are different than the properties of the individual nonwoven fiber mats.

Step 108 is directed to compressing the stacked plurality of nonwoven fiber mats. The compression of the stacked plurality of nonwoven fiber mats may be arranged in a predetermined configuration or shape to form the carbon monolith. Compression of the stacked plurality of nonwoven fiber mats may done in a mold or press. The shape of the carbon monolith may be similar to the shape of the stacked plurality of nonwoven fiber mats, such as cylinders, cuboids, and the like. The compression of the stacked plurality of nonwoven fiber mats may change the overall properties of the carbon monolith relative to the individual properties of the carbon fibers and the individual nonwoven fiber mats.

Step 110 is directed to fusing the carbon fibers at contact points between touching carbon fibers. In other words, the carbon fibers fuse together at points where adjacent carbon fibers physically touch each other. In some example, a single carbon fiber may fuse to multiple different adjacent carbon fibers. Due to the random orientation of each carbon fiber, each carbon fiber may physically contact multiple other carbon fibers. Due to the plurality of nonwoven fiber mats, the carbon monolith includes one or more internal channels with high surface area within the carbon monolith.

The fusing of the carbon fibers may occur during an oxygen stabilization process. During the oxygen stabilization process, the carbon fibers self-fuse to another other carbon fiber at contact points between adjacent fibers. The fusing of the carbon fibers may occur at a number of different times during the manufacturing process. For example, the carbon fibers may be fused after the nonwoven fiber mat is formed after melt blowing. In another example, the carbon fibers may be fused after stacking the plurality of nonwoven fiber mats. In another example, the carbon fibers may be fused after compressing the stacked plurality of nonwoven fiber mats to form the monolithic structure of the carbon monolith. In some examples the carbon fibers are fused one or more time along the manufacturing process.

The fusing of the carbon fibers enables the carbon monolith to be formed. In contrast with the prior art, the carbon monolith is formed from a plurality of carbon fibers without the use of a binder agent, such as a resin binder, a phenolic bind, or a PVDC binder. The disclosed method 100 of manufacturing of the carbon monolith does not use a binder to bind the plurality of carbon fibers together. In other words, the carbon monolith is free of binders. The resulting carbon monolith formed from the disclosed method 100 of manufacturing has a plurality of nonwoven fiber mats that each include melt blown carbon fibers.

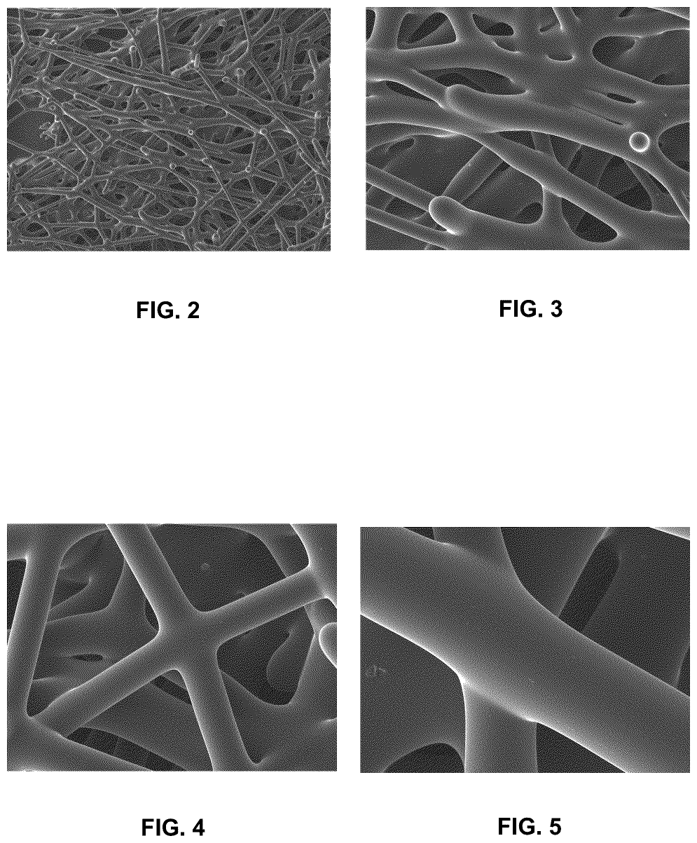

FIG. 2 illustrates a scanning electron microscope (SEM) image of melt blown carbon fibers from coal based pitch after oxidation showing the resulting union of carbon fibers at the nodes of intersection between adjacent carbon fibers. The image in FIG. 2 is at 144 times magnification.

FIG. 3 illustrates a SEM image of melt blown carbon fibers from coal based pitch after oxidation showing the resulting union of carbon fibers at the nodes of intersection between adjacent carbon fibers. The image in FIG. 3 is at 595 times magnification.

FIG. 4 illustrates a SEM image of melt blown carbon fibers from coal based pitch after oxidation showing the resulting union of carbon fibers at the nodes of intersection between adjacent carbon fibers. The image in FIG. 4 is at 907 times magnification.

FIG. 5 illustrates a SEM image of melt blown carbon fibers from coal based pitch after oxidation showing the resulting union of carbon fibers at the nodes of intersection between adjacent carbon fibers. The image in FIG. 5 is at 2,280 times magnification.

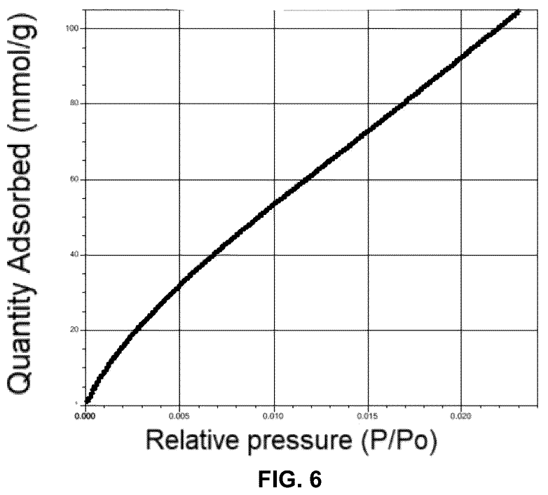

FIG. 6 shows a graphical representation of the quantity of carbon dioxide adsorbed per gram of carbon monolith and the relative pressure increase. The graph shows the CO₂ adsorption capacity of an example carbon fiber monolith. The monoliths experienced a pressure drop of 0.1 Psi or 820 Pa. The example demonstrates that the monoliths have a high open pore volume, which can be greater than 90% volume, which provides the low indicated pressure drop. The monoliths have a high CO₂ adsorption capacity and low CO₂ desorption energy.

As discussed above, the carbon fibers and the carbon monolith may be optimized for filtration and specification for adsorption of atoms, ions, or molecules from a gas, liquid or dissolved solid to a surface of the carbon fibers of the carbon monolith. The carbon monolith may be activated by heating or another treatment to increase the adsorptive power of the carbon monolith. In some examples, the carbon fibers of the carbon monolith may be activated by heating or another treatment to increase the adsorptive power of the carbon fibers of the carbon monolith.

The properties of the carbon fibers and the carbon monolith may be customized based on the manufacturing process to target and adsorb specific compounds, such as volatile organic compounds, aqueous greenhouse gases, air contaminants, humidity from air, and the like. Examples of the potential target compounds of volatile organic compounds include dehydes, pinenes, formaldehydes, and the like. Examples of potential target compounds of aqueous greenhouse gases include methane, nitrous oxide, carbon monoxide, carbon dioxide, and the like.

Properties that may be customized for the targeting potential target compounds include the density of the carbon monolith, the pore structure of the carbon monolith, the average pore diameter of the carbon monolith, the porosity of the carbon monolith, the BET surface area of the carbon monolith, the thermal conductivity of the carbon monolith, the electrical resistance of the carbon monolith, and the like. In some examples, combinations of multiples properties may be customized to target specific target compounds, whereas in other examples, one or two properties may be customized to target specific target compounds.

In some examples, the density of the activated carbon monolith may be customized to target specific compounds.

In some examples, the pore structure of the activated carbon monolith may be customized to target specific compounds. For example, average pore diameter and the porosity of the carbon monolith may be customized to target specific compounds.

In some examples, the BET surface area of the activated carbon monolith may be customized to target specific compounds. In some examples, the BET surface area can be between about 1000 m²/g and about 2000 m²/g. The BET surface area can be between about 1200 m²/g and about 1800 m²/g, between about 1400 m²/g and about 1600 m²/g, or between about 1400 m²/g and about 1500 m²/g.

In some examples, the activated carbon monolith may include a thermal conductivity that is conducive to regeneration of the carbon monolith after the carbon monolith has adsorb a predetermined adsorption capacity. In some examples, the carbon monolith can include an adsorption capacity of about 0.5 g/g CO₂ or 0.35 g/g CO₂. In other examples, the adsorption capacity can be in ranges between about 0.02 g/g CO₂ and about 1 g/g CO₂, between about 0.2 g/g CO₂ and about 0.8 g/g CO₂, between about 0.4 g/g CO₂ and about 0.6 g/g CO₂, or between about 0.4 g/g CO₂ and about 0.5 g/g CO₂.

In some examples, the activated carbon monolith may include an electrical resistance that is conducive to regeneration of the carbon monolith after the carbon monolith has adsorb a predetermined adsorption capacity.

In some examples, the average carbon fiber diameter of the carbon monolith may be customized to target specific compounds.

The carbon monoliths discussed above may be used in a variety of different settings. The carbon monoliths can be used in large-scale electro-thermal desorption applications. Examples of potential large-scale electro-thermal desorption applications includes U.S. Provisional Patent Application No. 63/481,987 titled “Systems and Methods for Coal-Based Electrothermal Swing Adsorption of Aqueous Greenhouse Gases from Wastewater” filed Jan. 27, 2023, U.S. Provisional Patent Application No. 63/483,223 titled “Systems and Methods for Dehumidifying and Purifying Air through Coal-Based Electrothermal Swing Adsorption” filed Feb. 3, 2023, all of which are incorporated by reference in their entireties.

As used herein, the term “about” or “substantially” refers to an allowable variance of the term modified by “about” or “substantially” by +10% or +5%. Further, the terms “less than,” “or less,” “greater than,” “more than,” or “or more” include, as an endpoint, the value that is modified by the terms “less than,” “or less,” “greater than,” “more than,” or “or more.”

While various aspects and embodiments have been disclosed herein, other aspects and embodiments are contemplated. The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including” and “having” come as used in the specification and claims shall have the same meaning as the term “comprising.”

What is claimed is:

1. A method of manufacturing a carbon monolith comprising:
obtaining coal based pitch;
melt blowing the coal based pitch into a plurality of carbon fibers forming a nonwoven fiber mat;
fusing the plurality of carbon fibers at contact points between the carbon fibers; and
shaping the fused carbon fibers.

2. The method of claim 1, further comprising melt blowing the coal based pitch into a plurality of nonwoven fibers mats, each nonwoven fiber mat comprises a plurality of carbon fibers.

3. The method of claim 2, further comprising stacking the plurality of nonwoven fiber mats.

4. The method of claim 3, further comprising compressing the stacked plurality of nonwoven fiber mats to produce the carbon monolith with a predetermined density and pore structure.

5. The method of claim 2, wherein the plurality of carbon fibers of each nonwoven fiber mat are randomly oriented.

6. The method of claim 1, wherein the coal based pitch is isotropic.

7. The method of claim 1, wherein the coal based pitch is anisotropic.

8. The method of claim 1, wherein the coal based pitch is mesophase pitch.

9. The method of claim 1, wherein the fusing the plurality of carbon fibers occurs during an oxygen stabilization process.

10. The method of claim 1, wherein the method of manufacturing does not use a binder to bind the plurality of carbon fibers.

11. A carbon monolith comprising:
a plurality of nonwoven fiber mats compressed together to form the carbon monolith, wherein each nonwoven fiber mat of the plurality of nonwoven fiber mats comprises a plurality of melt blown carbon fibers, and
wherein the plurality of melt blown carbon fibers are fused together at contact points between adjacent melt blown carbon fibers.

12. The carbon monolith of claim 11, wherein the carbon monolith does not have a binder to bind the melt blown carbon fibers.

13. The carbon monolith of claim 11, wherein the carbon monolith is configured to adsorb volatile organic compounds.

14. The carbon monolith of claim 11, wherein the carbon monolith is configured to adsorb aqueous greenhouse gases from wastewater.

15. The carbon monolith of claim 11, wherein the carbon monolith is configured to dehumidify air.

16. The carbon monolith of claim 11, wherein the carbon monolith is configured to adsorb air contaminants.

17. The carbon monolith of claim 11, wherein the plurality of melt blown carbon fibers of each nonwoven fiber mat are randomly oriented.

18. A carbon monolith comprising:
a plurality of nonwoven fiber mats compressed together to form the carbon monolith, wherein each nonwoven fiber mat of the plurality of nonwoven fiber mats consists of a plurality of melt blown carbon fibers, and
wherein the plurality of melt blown carbon fibers are fused together at contact points between adjacent melt blown carbon fibers.

19. The carbon monolith of claim 18, wherein the plurality of melt blown carbon fibers of each nonwoven fiber mat are randomly oriented.

20. The carbon monolith of claim 18, wherein the carbon monolith is configured to adsorb a specific compound.
